(19) United States
(12) Patent Application Publication
(10) Pub. No.: US 2007/0015105 A1
(43) Pub. Date: Jan. 18, 2007

(54) Dental sleeve

(76) Inventor: John E. Campanello, Caldwell, NJ (US)

Correspondence Address: KATTEN MUCHIN ROSENMAN LLP, 575 MADISON AVENUE, NEW YORK, NY, 10022-2585, US

(21) Appl. No.: 11/180,981

(22) Filed: Jul. 13, 2005

(51) Int. Cl. A61C 19/00

(52) U.S. Cl. 433/74

(57) ABSTRACT

A coupling assembly for removably coupling a die and base of a dental model includes a sleeve configured to slidably receive a pin, which is fixedly mounted to the inner surface of the die. The sleeve has at least one slot extending through the body thereof and configured to receive and retain base material molding around the sleeve so as to have the sleeve and base displaceably fixed to one another during repeated couplings of the die to the base.

### BACKGROUND OF THE INVENTION

1. Field of the Invention

The invention relates to a coupling assembly configured to removably attach a die and base of a dental model to one another in a manner, in which the sleeve of the coupling assembly and base remain fixed relative to one another.

2. Background

Crown and bridge works necessitate the use of a model fitting the teeth and jaws of a patient. Constructing models of patient's teeth includes forming a negative impression of the teeth. The impressions of particular teeth or tooth to be worked on are then filled with a die material to form a positive replica of the teeth or tooth called a die. Typically, the die is removably placed on a base, which fits the jaws, and is periodically decoupled from the base for adjusting shapes and dimensions of the positive replica of teeth or tooth.

Conventionally, the die is coupled to the base by pins, which are usually cemented in holes (for example, as prepared by a drilling machine as disclosed by U.S. Pat. No. 3,941,496 to Weissman which is hereby incorporated by reference) in the die material in a manner preventing their removal or rotation. Frequent decoupling of the die from the base can detrimentally affect subsequent coupling between the base and die, and eventually the positive replica of teeth.

To facilitate repeated insertion and removal of the die, the base is provided with sleeves each shaped and dimensioned to receive a respective pin. Embedding the sleeves in the base involves initially placing the sleeves over respective pins and subsequently inserting the sleeve/pin coupling assembly into material used for forming the base before the material is set. As a result, upon setting the base material, the pin can slide into and out of the sleeve allowing easy removal and reinsertion of the dies into the base with relative ease.

Model construction is not easy, and can require a substantial amount of time to complete. As previously noted, with frequent displacement of the die from the base, coupling between material of the base and the sleeve may gradually deteriorate, which, in turn, may lead to a linear or a rotational motion of the sleeve relative to the base during the removal and insertion of the die. As a consequence, the die may be incorrectly mounted in relation to the base and, eventually, contribute to an unsatisfactory model of the patient's teeth. This undesirable phenomenon may be particularly likely in a single pin/sleeve assembly dental model.

To date, attempts to minimize displacement of the sleeve relative to the base have been mainly associated with changing the sleeve's geometry. For example, in one approach, the sleeve is formed with a flange, which is provided on the outer end of the sleeve and continuously extends around the periphery of the sleeve's body. A further modification includes a plurality of spaced apart protrusions located between the opposite ends of the body of the sleeve. Still another modification provides for an arrangement of spaced apart ribs extending along the periphery of the body.

Furthermore, it is known to provide the sleeve with an arrangement of slots adapted to minimize rotation of the sleeve relative to the pin. For instance, U.S. Pat. No. 6,672,869 to Rabenstein et al. discloses a sleeve having opposite slots at one end of the sleeve serving as a securing means for preventing relative displacement between the pin and sleeve, not between the sleeve and base.

U.S. Pat. No. 5,762,500 to Lazarof discloses a sleeve having slits extending over at least half-length of the sleeve and adapted to enable for the outwards movement of anchor segments as a tightening means when so urged by an expansion nut.

U.S. Pat. No. 6,524,106 to Ziegler discloses a sleeve having multiple fingers defined by a plurality of slots separating the fingers at one end of the sleeve. The slots facilitate outward movement of the fingers to frictionally contain a corresponding dental fixture inserted into the sleeve.

U.S. Pat. No. 3,934,347 to Lash disclose external grooves for dental sleeves which are generally used as retention and non-rotational mechanisms.

U.S. Pat. No. 5,788,494 to Phimmasone discloses a sleeve including a flat employed as a retention means, and a notch at an upper end of the sleeve for receiving a locator lug for a pin.

In the above-referenced prior art sleeves, the disclosed retention means may still be inadequate for ensuring a fixed position of the sleeve relative to the base, particularly when a die is adopted for a one-tooth, single pin model.

A need, therefore, exists for a dental model of the above-disclosed kind constructed in a manner that further reduces the possibility of displacement between a sleeve and a base.

### SUMMARY OF INVENTION

The present invention is directed to a method and apparatus that satisfy these needs. The invention includes a method of constructing a dental model including a die, base and a coupling assembly for removably attaching the base to the die, which has an outer surface thereof provided with a replica of at least one tooth to be worked on. The method is implemented by initially fixedly mounting a pin of the fastening assembly to the inner surface of the die. After a sleeve of the fastening assembly has been placed over the pin, the die/coupling assembly is placed into base material, which, while setting to form the base, molds around the sleeve.

In accordance with one aspect of the invention, the sleeve is provided with a slot fully extending between opposite inner and outer faces of the sleeve and configured to be filled with base material. As the latter sets, a bond between the slot and retained material is formed so that the sleeve is fixed in the base for a prolonged period of time necessary for multiple removal and reinsertion of the die from and into the base, respectively.

Various shapes and dimensions of the slot are envisioned within the scope of the invention. However, all modifications are associated with achieving a reliable retention of the base material in the slot, which substantially minimizes a possibility of rotation of the sleeve relative the base. The slot may be shaped as a rectilinear slit extending parallel to the longitudinal axis of the sleeve. Another modification includes the rectilinear slot extending transversely to the longitudinal axis of the sleeve. Yet a further modification may include a plurality of aligned and spaced apart rectilinear slots extending between the top and bottom of the sleeve. Still other modifications of the slot's geometry may include a spirally extending and curved slot.

Having the slot fully split the sleeve has a few advantages. The fully-split slot provides a reliable retention mechanism for securing the desired position of the sleeve relative to the base. The bond provided by the base material filling the slotted sleeve minimizes undesirable rotational motion between these components.

A further advantage is particularly related to the slot extending between the top and bottom of the sleeve and transversely to the sleeve's longitudinal axis. As the material of the base travels into and sets in the slot, not only rotational motion of the sleeve is arrested, but also linear displacement of the sleeve and base relative to one another is resisted as well.

Still another advantage of the inventive sleeve includes a simple and economically effective process of manufacturing. Having a fully-split slot makes the sleeve flexible and expandable for penetration of the pin. As a result, an amount of material used for its manufacturing can be reduced, which may lead to tighter, easily controllable tolerances between the pin and the sleeve upon insertion of the pin.

In accordance with a further aspect of the invention, the wall of the sleeve may have a uniform thickness. Alternatively, the bore to the sleeve may be slightly eccentric so that the wall thickness is not uniform, so as to provide a characteristic “feel” to pin insertion.

These and other features and aspects of the present invention will be better understood with reference to the following description, figures, and appended claims.

### BRIEF DESCRIPTION OF THE FIGURES

A more complete understanding of the invention may be obtained by reading the following description of specific illustrative embodiments of the invention in conjunction with the appended drawing in which:

FIG. 1 illustrates a dental model of the jaw of a patient provided with a die, base and a coupling assembly for removably attaching the die to the base;

FIG. 2A illustrates an elevational view of a sleeve of the coupling assembly of FIG. 1 configured in accordance with one embodiment of the invention;

FIG. 2B illustrates a sectional view of the sleeve of FIG. 2A taken along lines B-B and showing alternating interengaged layers of base material and sleeve, which effectively resist bending and torsional forces associated with repeated removal and insertion of the die into the base of the dental model of FIG. 1.

FIG. 3 illustrates an elevational view of a sleeve configured in accordance with a second embodiment of the invention;

FIG. 4 illustrates an elevational view of a sleeve configured in accordance with a third embodiment of the invention;

FIG. 5 illustrates an elevational view of a sleeve configured in accordance with a fourth embodiment of the invention;

FIG. 6 illustrates an elevational view of a sleeve configured in accordance with a fifth embodiment of the invention;

FIG. 7 illustrates an elevational view of a sleeve configured in accordance with a sixth embodiment of the invention;

FIG. 8 illustrates an elevational view of a sleeve configured in accordance with a seventh embodiment of the invention;

FIG. 9 illustrates an elevational view of a sleeve configured in accordance with a ninth embodiment of the invention;

FIGS. 10A, 10B and 10C illustrate plan side, top sectional and side sectional views, respectively, of a sleeve configured in accordance with still a further embodiment of the invention; and

FIGS. 11A and 11B are side and top views, respectively, of a pin used in conjunction with any of the embodiments of the inventive sleeve.

### DETAILED DESCRIPTION

Reference will now be made in detail to several embodiments of the invention that are illustrated in the accompanying drawings. Wherever possible, the same or similar reference numerals are used in the drawings and the description to refer to the same or like parts or steps. The drawings are in simplified form, and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms do not necessarily denote direct and immediate connections, but also include connections through mediate elements or devices.

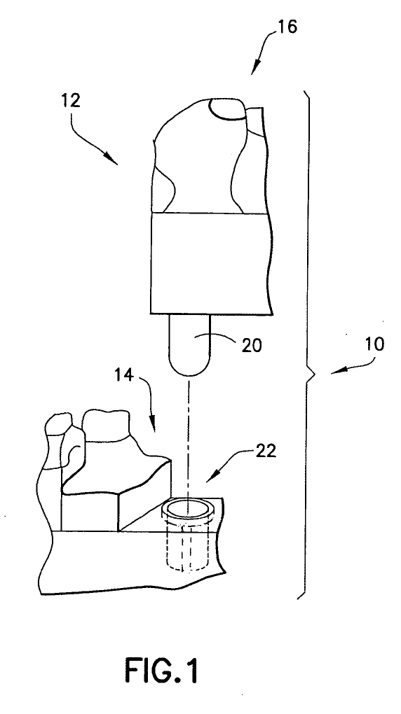

Referring more particularly to the drawings, FIG. 1 illustrates a dental model 10 for the patient's jaw. The model is configured with a die 12 having an outer surface with a replica of the patient's teeth 16 to be worked on. The inner surface of die 12 carries a pin 20 configured to slide into a sleeve 22 embedded in a base 14 of model 10. The pin 20 and sleeve 22 constitute a coupling assembly for removably attaching die 12 to base 14.

The sleeve 22 is shaped and dimensioned to receive pin 20 in a frictionally slidable manner ensuring repeated coupling and decoupling of die 12 and base 14. On the other hand, as will be further herein described, sleeve 22 is embedded in base 14 such that multi-time displacement of die 12 does not loosen a bond between sleeve 22 and base 14. As a result, sleeve 22 and base 14 may be displaceably fixed to one another allowing die 12 to be removed from and reinserted into base 14 whenever certain adjustments are to be made to tooth replica 16.

Coupling sleeve 22 to base 14 includes inserting pin 20 and sleeve 22, which is placed over the pin, into a not yet hardened material of base 14. Die 12 may be preferably mounted to pin 20 to provide a grabbing surface and to facilitate an appropriate alignment during the insertion. As the unhardened base material sets around sleeve 22, the latter is embedded in the base.

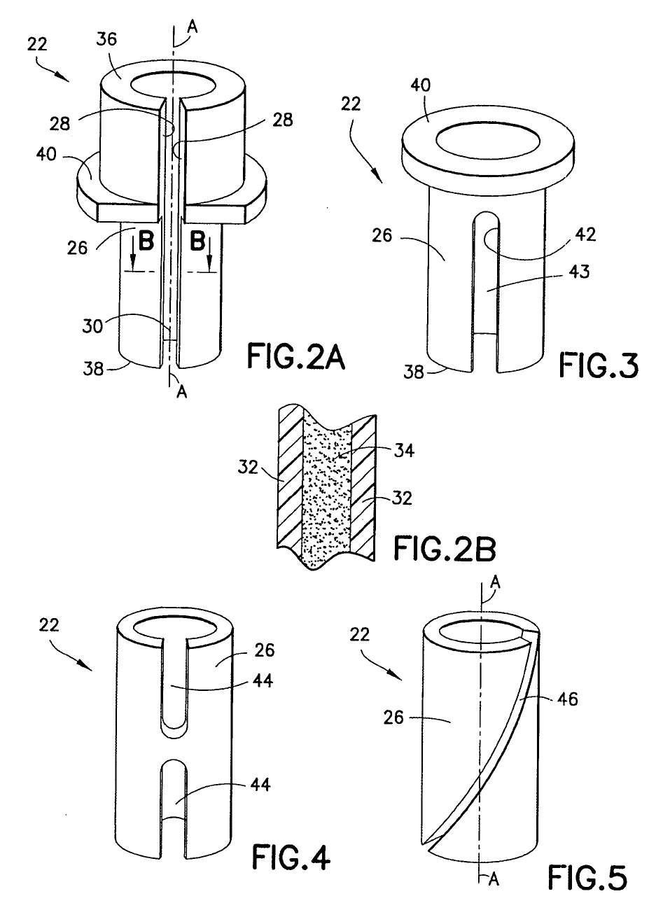

To minimize relative displacement between sleeve 22 and base 14 in general, and relative rotational motion in particular, in accordance with the present invention, sleeve 22 is provided with a slot. Configuration, dimension, and other characteristics of the slot will be further disclosed with reference to FIGS. 2-11.

Referring to FIG. 2A, sleeve 22 is provided with a slot 30 extending through a body 26 of the sleeve and opening into its opposite inner and outer faces. Base material can be made to flow into slot 30 to at least partially fill slot 30 between opposite edges 28 defining slot 30.

Thus, as shown in FIG. 2B, with reference to section B-B of FIG. 2A a resulting structure base/sleeve includes a layer of hardened base material 34 and adjacent regions 32 of sleeve wall 32 bonded to one another. Preferably, a rubber base mold (not shown) is used for receiving unhardened base material 34 which advantageously, but not exclusively, includes a class IV die stone. The sleeve 22 may be made from different materials including metals and polymeric materials, such as brass, celcon acetyl, polyethylene, styrene, and the like. Polymeric sleeves may be formed by extension molding, using any polymeric material suited for extension molding.

The concept of the slotted sleeve can be illustrated by various embodiments and modifications. Thus, FIG. 2A features a rectilinear slot extending between top and bottom sections 36 and 38, respectively, and parallel to a longitudinal axis of sleeve 22. Further, the sleeve, as shown in FIG. 2A, has a flange 40 providing an additional support surface between the sleeve and base material 34.

A further embodiment of sleeve 22, denoted as the “second” embodiment only for descriptive purposes, is shown in FIG. 3 and includes body 26 having flange 40, which is provided on the top end section of body 26. In contrast to the embodiment of FIGS. 2A and 2B, this embodiment features a slot 43 that does not extend along the entire length of body 26, but terminates at a distance from flange 40. Preferably, slot 43 extends along a substantial portion of the length of sleeve 22. As depicted, slot 43 has an inverted U-shaped cross-section having an arcuate bottom 42. However, the slot may have various shapes and dimensions as long as the base material can flow in and harden within the slot to form a structure capable of resisting torsional and bending moments during removal and reinsertion of the die.

FIG. 4 is a modification of FIG. 3 and includes a pair of linearly aligned slots 44 extending through the body of sleeve 22. Extending from opposite top and bottom ends of sleeve's body 26, slots 44 terminate at a distance from one another in a substantially central region of the sleeve. Furthermore, in contrast to the above-discussed embodiments, sleeve 22 of FIG. 4 does not have a flange. However, if needed, a further modification of sleeve 22 of FIG. 4 may provide, for example, one of the flanges shown in FIGS. 2 and 3 positioned for example near the top or alternatively at the middle of the sleeve.

FIG. 5 illustrates a further, particularly advantageous embodiment of inventive sleeve 22. Like in FIG. 2, a slot 46 extends along the entire length of body 26 and may be at least partially filled with the base material for displaceably fixing the sleeve to the base. Unlike the slot of FIG. 22, however, slot 46 extends transversely to the central longitudinal axis (A-A) of the sleeve 22.

Transversally extending slot 46 not only resists rotational moments, but it resists axial displacement of sleeve 26 relative to base 14 (FIG. 1). Shown as curved, slot 46 may be rectilinear, parabolic, spherical and the like as long as a plane in which it extends between the top and bottom sections of sleeve 26 is not parallel to the plane of the central axis. The transversely extending slot is particularly advantageous since it is characterized by a larger length, which, in turn, offers a potentially greater fill volume for the base material. As a consequence, retention characteristics can be significantly improved.

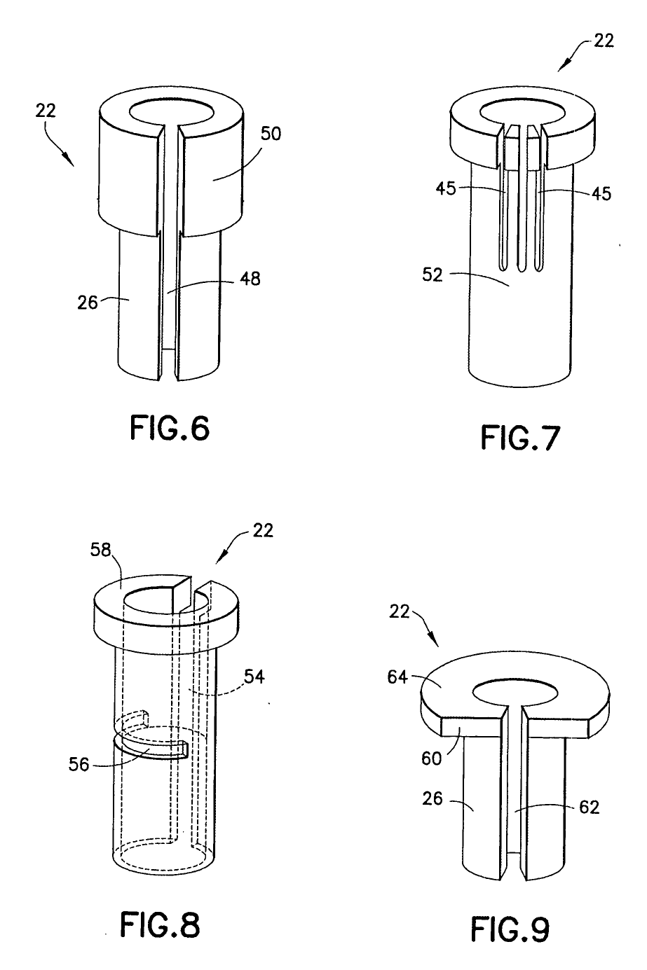

Another modification of sleeve 22 is illustrated in FIG. 6 and includes the top section of sleeve's body 26 provided with a flange 50, which extends between the top section of body 26 and the body's midsection. Alternatively, the position of flange 50 may be inverted so that the flange extends from the midsection of body 26 to the bottom section of body 26. Consonant with the main concept of the invention, entire body 26 including the flange is split by slot 48 which subsequently may be at least partially filled with the base material so as to serve as a retention mechanism for retaining the sleeve in a fixed position relative to the molded base material. Similarly to the previous embodiments, a variety of slots of different shapes and sizes can also be utilized in this embodiment.

FIG. 7 illustrates sleeve 22 provided with angularly or circumferentially aligned slots 45, which are spaced apart either at regular or irregular distances. An arrangement of angularly spaced slots may be provided at either one of the top and bottom sections of body 26 or both. Although the latter modification is not shown, it is similar to the embodiment of FIG. 4, but would have several slots instead of a single slot on each of the opposite ends of the sleeve.

The present invention fully contemplates a variety of shape and size modifications for the illustrated slot configurations. For example, to this point, the inventive slots have been disclosed as having a uniform width. However, although not shown, it is contemplated within the scope of the present invention that each slot may alternatively have a variable width defined between the opposite edges of the slot. Thus, the edges may be spaced at a greater angular distance from one another, for example, along the bottom section of sleeve 22 and a smaller angular distance along the top section of sleeve 22. Having a broader layer of base material formed along the bottom section of the sleeve increases resistance to torsional forces applied to the sleeve during insertion and removal of the die. Alternatively, having a broader layer of material at the top of the sleeve increases its resistance to linear forces applied to the sleeve during insertion and removal of the die. It should be understood that all and any of these discussed modifications can be implemented in each and every disclosed embodiment of the inventive sleeve.

A further embodiment of the inventive sleeve includes a combination of slots, as shown in FIG. 8. The sleeve 22 is provided with a slot 54 running through the entire length of sleeve and splits a top flange 58. In addition to slot 54, sleeve 22 has a circumferentially extending slot 56. The slot 56 may cross slot 54. Alternatively, circumferentially extending slot 56 may be angularly spaced from elongated slot 54, as shown in FIG. 8. Furthermore, the slot 56 is illustrated as extending substantially perpendicularly to slot 54, but may be configured at a different transverse angle with respect to slot 54.

Filling the slots 54 and 56 with the base material enhances the ability of the sleeve to resist differently directed forces, which are generated by the die during displacement thereof relative to the base. Slot 56 is depicted as being located substantially in the midsection of sleeve 22, but can also be easily near the top or bottom of sleeve 22. The widths of slots 54 and 56 do not have to be uniform, and, thus, may vary.

In accordance with a further modification of the inventive sleeve 22, as shown in FIG. 9, sleeve's body 26 is formed with an elongated slot 62 running between the top and bottom sections of the body. A top flange 64, like many of the previously disclosed embodiments, is also split by slot 62. In contrast to the previously illustrated flanges, flange 64 has one straight peripheral segment 60. The rectilinear surfaces of segment 60 create better conditions for non-rotatably engaging the base material than are created by a fully annular flange surface. As a consequence, not only may flange 64 may have a rectilinear peripheral segment or segments, but also body 26, which has been depicted as being generally cylindrically shaped. For example, body 26 may be provided with flat rectilinear segments (not shown) extending between flange 64 and the bottom section of body 26.

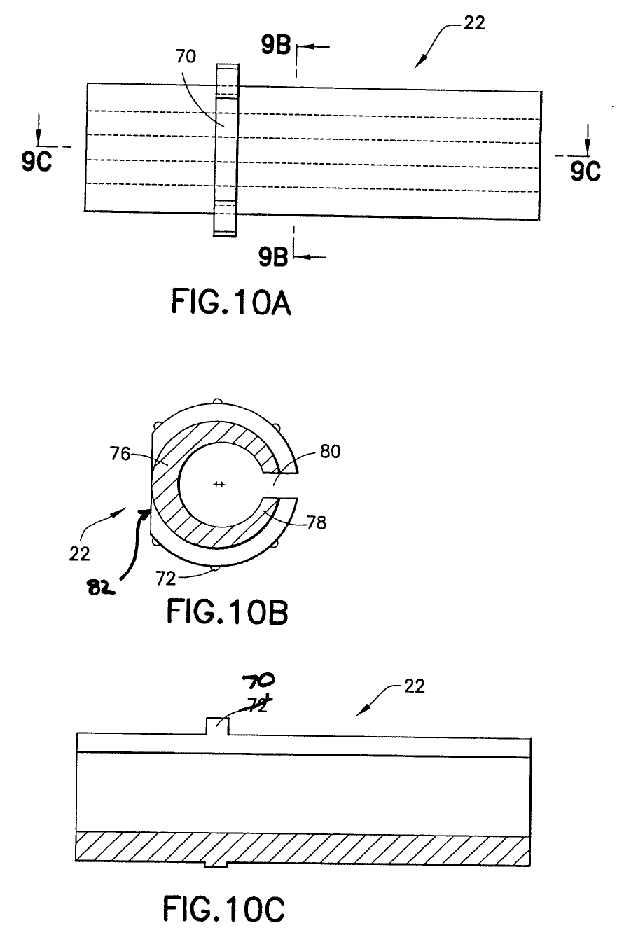

Turning to FIGS. 10A, 10B and 10C, a peripheral wall of sleeve 22 has a longitudinal slot 80 configured to retain base material so as to serve as a retaining mechanism for displaceably fixing the sleeve relative to the base, as explained above. In contrast to the previously discussed embodiments, the thickness of the peripheral wall is not uniform.

As shown in FIG. 10B, illustrating a sectional view of the sleeve 22 as seen at section 9B of FIG. 10A, the thickness of the peripheral wall gradually reduces from a segment 76, which is distant from slot 80, to segments 78 located adjacent to slot 80. As a consequence, a bore provided in sleeve 26 and configured to slidably receive pin 20 (FIG. 1) is located eccentrically relative to the outer periphery of the sleeve. Inserting the pin into the eccentrically formed bore may act to enhance the practitioner's feel for guiding the pin.

Also, sleeve 22 of FIGS. 10A, 10B and 10C is provided with a flange 70 that has a rectilinear portion 82 better seen in FIG. 10B. To further improve engagement between the sleeve and base material, a peripheral wall of flange 70 may further have one or more radially extending cavity markers 72. Cavity markers 72 may be selectively applied on the peripheral wall of flange 70 in order to provide identification means for identifying sleeves having different dimensional properties. For example, a first sleeve may have one identifying marker, a second sleeve may have two identifying markers and so on. In addition, the relative angular positions of adjacent markers may be used to identify sleeve configurations. Other means may also be used to identify sleeve configurations, for example including ribs (not shown) positioned radially on a upper or lower surface of flange 70, or alternatively on a peripheral wall of sleeve 22.

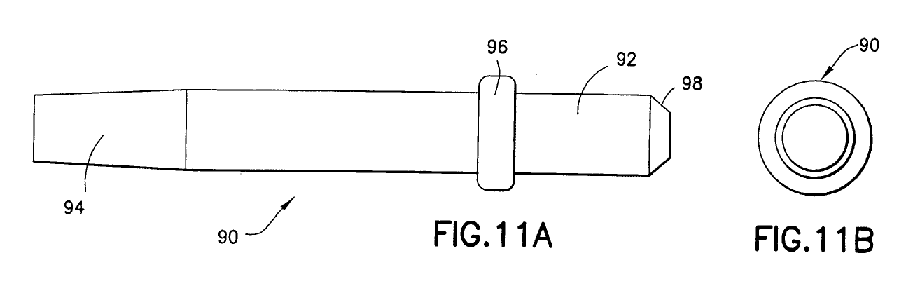

Turning now to FIGS. 11A and 11B, pin 90 is configured with an elongated body having an outer end 92 typically cemented in a respective hole drilled in the underside of die 12 (FIG. 1). Preferably, an end region 98 of the upper end is chamfered. A bottom end 94 of pin 90 may be generally longer than upper end 92 and have a substantially frustoconical cross-section.

The pin 90 is also provided with a flange 96 for abutting the die and signaling the desired positioning of the pin relative to the dies. The pins may come in different sized generally categorized as long, medium and short. Each of the categorized pins is received in a respective sleeve.

The outer diameter of the bottom end of pin 90 is so configured that, when the pin is initially inserted into the sleeve, further displacement of the pin creates friction between the sleeve and pin, since the inner diameter of sleeve 22 is either substantially the same as or slightly greater than the outer diameter of the pin. Configuration of the pin is selected so that when the pin and sleeve are inserted into the base material, the base material is prevented from penetrating into the bore of the sleeve and adhering to the pin.

In this regard, the inventive sleeve with the disclosed slot, even if the slot extends along only a portion of the entire length of the sleeve, is much more flexible than a not slotted sleeve. As result, it is possible to achieve tighter tolerances and reduce the amount of material used for manufacturing the pins, which may be made for example from brass, if the sleeve is slotted in accordance with the above disclosed numerous embodiments of the sleeve.

Since the pins have a variety of categorized dimensions, it is possible to color code pins having one color for short pins, another for medium size pins and still another for long pins. Accordingly, the sleeves may be color coded as well.

Furthermore, although as shown in FIGS. 1-11 the sleeve and pin are substantially cylindrical, other shapes are envisioned within the scope of this invention. For example, portions of each of the sleeve and pin may be conically shaped. Also, while pin 90 as shown in FIGS. 11A and 11B has a single body, other configurations of the pin, for example, a combination of three differently dimensioned pins coupled together, may be used as well with an appropriately configured sleeve that necessarily has at least one slot for receiving and retaining the base material.

This document describes the dental sleeve, coupling assembly and method of producing a dental model using the coupling assembly for illustration purposes only. Neither the specific embodiments of the invention as a whole, nor those of its features limit the general principles underlying the invention. In particular, the invention is not limited to any concrete materials, or shapes of the disclosed sleeves flanges and or pins or their dimensions. The specific features described herein may be used in some embodiments, but not in others, without departure from the spirit and scope of the invention as set forth. Many additional modifications of example sleeves described in the foregoing disclosure are contemplated within the scope of the present invention, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is served by the claims and their equivalents.

1. A sleeve for removably receiving a pin, the sleeve being embedded in a base and the pin in a die of a dental model, the sleeve comprising:
a body provided with at least one slot extending through the body and opening into opposing surfaces of the body, the slot being configured to receive unhardened material of the base of the dental model so that the sleeve and base are displaceably fixed relative to one another upon molding the material around the sleeve and hardening of the material in the at least one slot.

2. The sleeve of claim 1, wherein the at least one slot is substantially rectilinear and extends generally parallel to a longitudinal axis of the sleeve between axially spaced top and bottom sections of the body.

3. The sleeve of claim 1, wherein the at least one slot is substantially rectilinear and extends transversely to a longitudinal axis of the sleeve between axially spaced top and bottom sections of the sleeve.

4. The sleeve of claim 1, wherein the at least one slot extends spirally along the body between spaced apart top and bottom sections of the body.

5. The sleeve of claim 1, wherein the body is provided with a second slot extending between the opposite inner and outer faces of the body and transversely to the at least one slot.

6. The sleeve of claim 1, wherein the at least one slot extends through an entire length of the body.

7. The sleeve of claim 1, wherein the at least one slot extends through a partial length of the body.

8. The sleeve of claim 7 further comprising an additional slot, said additional slot having an end that is aligned with an end of the at least one slot and being spaced therefrom at a distance along the body of the sleeve.

9. The sleeve of claim 7 further comprising a plurality of additional slots spaced circumferentially around the body, each of said plurality of additional slots being aligned substantially parallel to the at least one slot.

10. The sleeve of claim 1, wherein the at least one slot has a uniform width.

11. The sleeve of claim 1, wherein the at least one slot has a non-uniform width (It is so clear from the existing drawings and disclosure that examine will likely let it fly with illustrations).

12. The sleeve of claim 1, wherein the body of the sleeve has a flange extending radially outwards from the body.

13. The sleeve of claim 12, wherein the flange is split by the at least one slot.

14. The sleeve of claim 12, wherein the at least one slot terminates at a predetermined distance from the flange.

15. The sleeve of claim 1, wherein the at least one slot is curved.

16. The sleeve of claim 1, wherein the body of the sleeve has at least one flat segment extending between top and bottom sections thereof (I'm not sure what this means).

17. A coupling assembly for constructing a dental model including a die with a replica of at least one tooth and a base, the coupling assembly comprising:
a pin displaceably fixed to an inner surface of the die; and
a sleeve having a body defining a bore for removably receiving the pin, the body being provided with an elongated slot extending through the body and configured to receive and retain material of the base upon embedding the sleeve in the base so as to prevent relative displacement between the sleeve and base while repeatedly inserting the pin into the sleeve.

18. The coupling assembly of claim 17, wherein the elongated slot is selected from the group consisting of a substantially rectilinear slot extending generally parallel to a longitudinal axis of the sleeve, substantially rectilinear slot extending transversely to the longitudinal axis of the sleeve, spirally extending slot, curved slot and a combination thereof.

19. The coupling assembly of claim 17, wherein the body is provided with a second slot extending through the body transversely to the elongated slot.

20. The coupling assembly of claim 17, wherein the elongated slot extends substantially along an entire length of the body.

21. The coupling assembly of claim 17, wherein the elongated slot extends through a partial length of the body.

22. The coupling assembly of claim 21 further comprising an additional elongated slot, said additional slot having an end that is aligned with an end of the at least one slot and being spaced therefrom at a distance along the body of the sleeve.

23. The coupling assembly of claim 21 further comprising at least one additional elongated slot spaced circumferentially around the body, each of said plurality of additional slots being aligned substantially parallel to the at least one slot.

24. The coupling assembly of claim 17, wherein the bore extends concentrically with the body of the sleeve, whereas the body has a uniform thickness.

25. The coupling assembly of claim 17, wherein the bore is eccentrically located relative to the body of the sleeve.

26. The coupling assembly of claim 17, wherein the body of the sleeve has a flange extending radially outwards from the body.

27. The coupling assembly of claim 27, wherein the elongated slot splits the flange.

28. The coupling assembly of claim 17, wherein the pin comprises brass and the sleeve comprises a celcon acetyl.

29. A method of constructing a dental model comprising the steps of:
(a) fixedly mounting a pin to an inner surface of a die;
(b) placing a sleeve over the pin;
(c) molding a base material around the sleeve, thereby providing a base; and
(d) simultaneously with step (c), filling a slot extending through a body of the sleeve with the base material, thereby providing a fixed relationship between the sleeve and the base relative to one another in a predetermined position.
